(19) United States
(12) Patent Application Publication
(10) Pub. No.: US 2026/0364769 A1
(43) Pub. Date: Nov. 19, 2026

(54) Torque Transmission Handtool

(71) Applicant: Alex Smith, Charlottesville, VA (US)

(72) Inventor: Alex Smith, Charlottesville, VA (US)

(21) Appl. No.: 19/450,110

(22) Filed: Jan. 15, 2026

Related U.S. Application Data
(60) Provisional application No. 63/808,051, filed on May 19, 2025.

(51) Int. Cl. B25G 1/12; B25B 23/00; B25G 1/08

(52) U.S. Cl. CPC B25G 1/125; B25G 1/085; B25B 23/0035

(57) ABSTRACT

A non-conductive hand tool is light weight, stiff, buoyant, comfortable to use, and suitable for a wide range of applications. The tool includes high-density foam that is captured between an outer shell handle and an inner shank. Evenly spaced splines radiate out from the shank towards the shell. The shell is irregular in its internal shape so that it can transmit torque from a user's hand to the high-density foam. In some embodiments, evenly spaced splines radiate inward toward the buried shank in center from the plastic outer shell.

### TECHNICAL FIELD

The invention relates to a non-conductive hand tool that is light weight, stiff, buoyant, comfortable to use, and suitable for a wide range of applications.

### SUMMARY

The current invention utilizes high-density foam to capture evenly spaced splines that radiate out halfway from the center of a buried polymer composite center shank towards an outer plastic shell handle. The shell is irregular in its internal shape so that it can transmit torque from a user's hand to the high-density foam.

In some embodiments, there are evenly spaced corresponding splines that radiate inward toward the buried shank in center from the plastic outer shell.

The cavity inside the handle surrounding the shank and splines is filled with a high-density closed-cell foam that, when cured, is rigid enough to transfer torque loads from outer shell to shank through the splines.

The tool is positively buoyant due to the closed-cell foam in the handle.

The tool is non-conductive due to using polymer composite for the shank, closed cell foam and plastic for the handle.

In some embodiments the shank is a nylon-12/glass fiber composite material.

The outer shell is formed from hard plastic such as ABS or nylon-6, with a TPU or similar soft plastic grip cover. In some embodiments the grip cover is textured.

The outer shell in some embodiments has a varied cross section along its length, with a lower portion that is triangular near the shank, an intermediate portion that is cylindrical, and an upper portion that is oblong. The varied cross section provides for adaptable torque with a similar hand force, depending where the user's hand may be positioned on the shell.

Where the center shank, which is connected to its 3 interior splines in one piece, exits the handle body there is a 6-sided section of the shank long enough to fit a wrench for higher torque applications.

In some embodiments, the end of the shank distal from the outer shell includes a hexagonal cavity for receiving a driver bit concentric with the shank.

At an upper end of the outer shell, there may be a threaded opening for receiving a threaded end cap. The threaded end cap may include a plurality of hexagonal cavities for holding driver bits.

The resulting design and construction provide a hand tool that is light weight, stiff, non-conductive, buoyant, and most of all-comfortable to use and suitable for a wide range of applications.

### BRIEF DESCRIPTION OF THE DRAWINGS

FIG. 1 shows an Isometric view of the hand tool.

FIG. 2 shows an Isometric Section view of the hand tool.

FIG. 3 shows a Front Section view of the hand tool.

FIG. 4 shows a Right view of the hand tool.

FIG. 5 shows a Right Section view of the hand tool.

FIG. 6 shows a Top view of the hand tool.

FIG. 7 shows a Top Section view of the hand tool.

FIG. 8 shows a Front view of the hand tool.

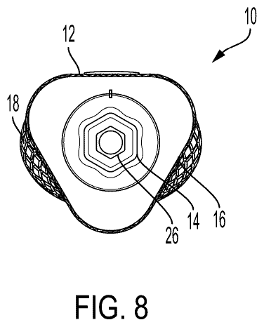

FIG. 9 shows another Front Section view of the hand tool.

### DETAILED DESCRIPTION

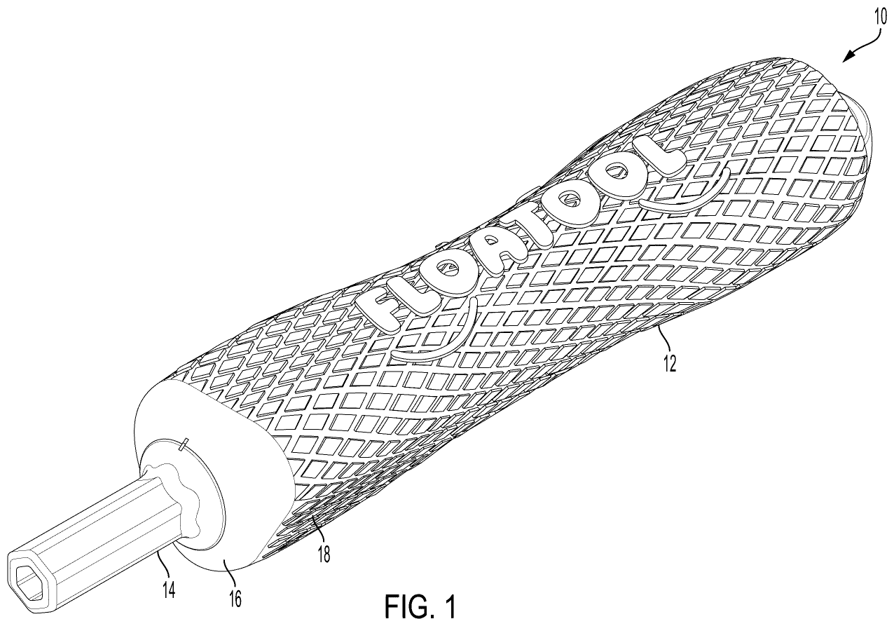

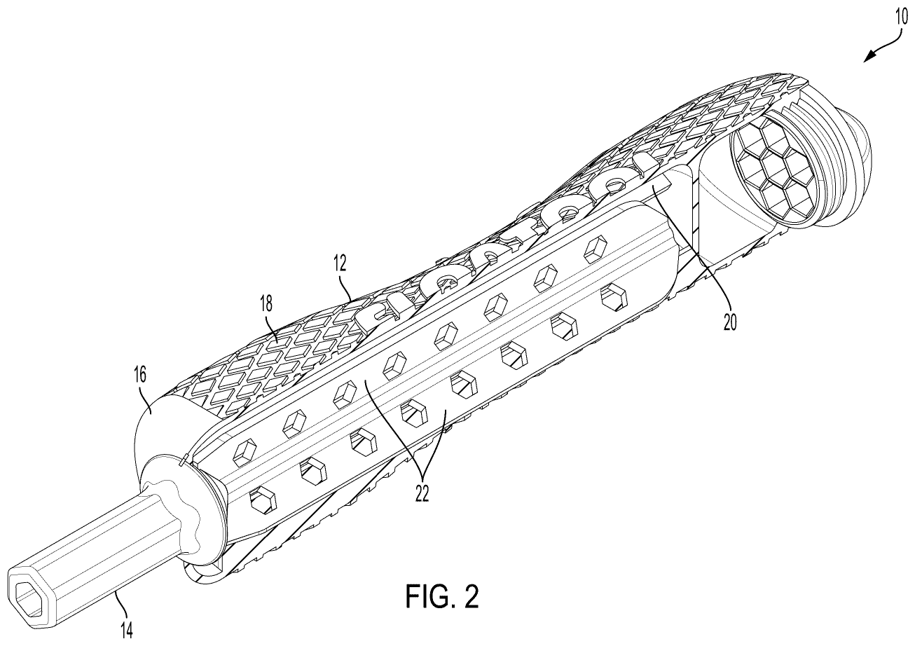

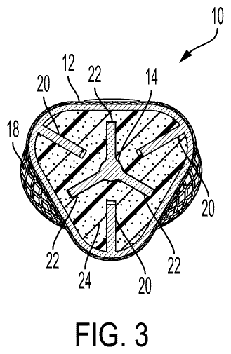

FIG. 1 shows an Isometric view of the hand tool 10. FIG. 2 shows an Isometric Section view of the hand tool. FIG. 3 shows a Front Section view of the hand tool. The tool comprises a handle 12 and a shank 14. The handle 12 has a stiff or substantially rigid plastic shell 16, which may be covered by a pliable or soft grip material 18. The shank 14 is formed of a rigid non-conductive material such as polymer-fiber composite. In some embodiments, the shell 16 is nylon-6 while the shank 14 is nylon-12/glass fiber composite. In some embodiments, carbon fiber or other non-conductive reinforcement may be used in place of glass. In some embodiments, ABS or other non-conductive matrix may be used in place of nylon-6 or nylon-12.

Inside the handle, three evenly spaced corresponding splines 22 protrude outward from the center shank towards the outer plastic shell. In some embodiments, three evenly spaced splines 20 also protrude inward from the plastic outer shell 16 toward the buried center shank 14. In other embodiments, the irregular internal shape of the outer shell, which may include protuberances or other structural elements, provides torque transfer to a closed cell foam 24 that is filled into the handle between the shell and the shank splines. The closed cell foam 24 engages the splines 22 to transfer torque to the shank. Examples of suitable closed cell foam include stiff materials such as polystyrene or polyurethane. Torque from a user's hand gripping the shell 16 transfers from the outer shell 16 (optionally through the outer splines 20) to the closed cell foam 24 and then from the closed cell foam to the shank 14 through the inner splines 22. The end of the shank distal from the handle 12 includes a hexagonal cavity 26 for receiving a standard driver bit.

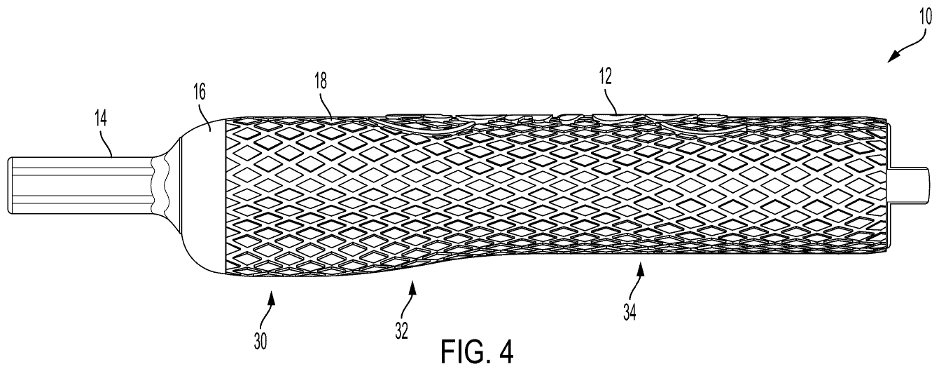

FIG. 4 shows a Right view of the hand tool. In the depicted embodiment, the shell 16 (which is substantially covered by the grip material 18) has a three-part varied cross-section with a lower part 30, an intermediate part 32, and an upper part 34. The lower part 30 is roughly triangular and is broader than the other two parts. The intermediate part 32 is roughly cylindrical and is smaller in cross-sectional area compared to the lower part 30. The upper part 34 is roughly oblong and has a similar cross-sectional area to the lower part 30. When a user grips the handle 12, they may position their hand to engage primarily with any single or combination of the three different cross sections. By selecting the primary cross section to engage, the user may optimize the comfort of their hand and also may select how much torque to exert on the shank 14 for a given hand force.

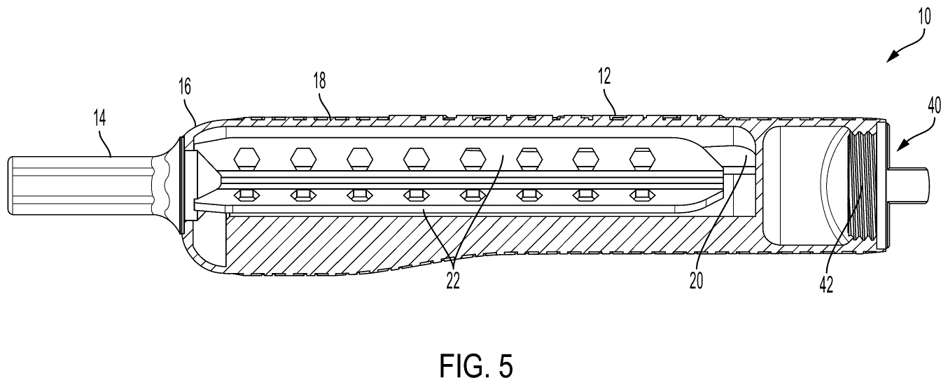

FIG. 5 shows a Right Section view of the hand tool, depicting two of the inner splines 22, one of the outer splines 20, the shank 14, and the outer shell 16. FIG. 5 also shows a lid or end cap 40 that is threaded into an opening at the upper end of the shell 16. An inner surface of the end cap 40 includes hexagonal cavities 42 for receiving driver bits. The end cap may also include a loop as shown for receiving a security clip or lanyard.

FIG. 5 shows a top view of the hand tool.

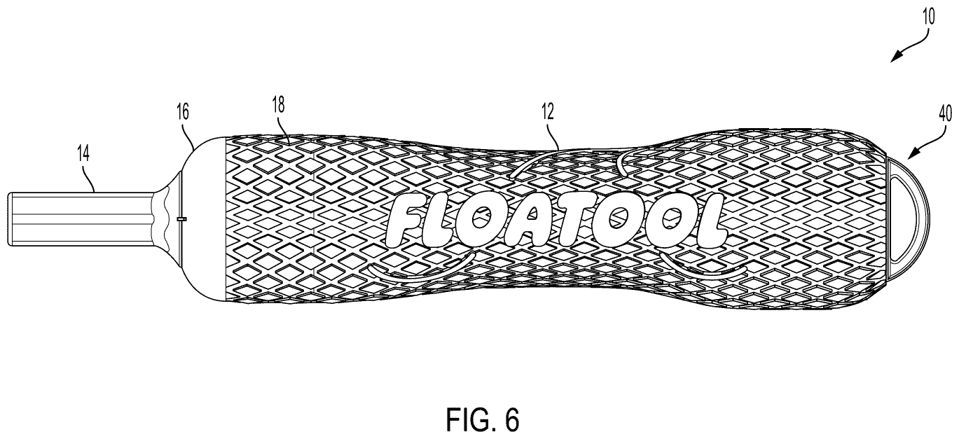

FIG. 6 shows a Top Section view of the hand tool.

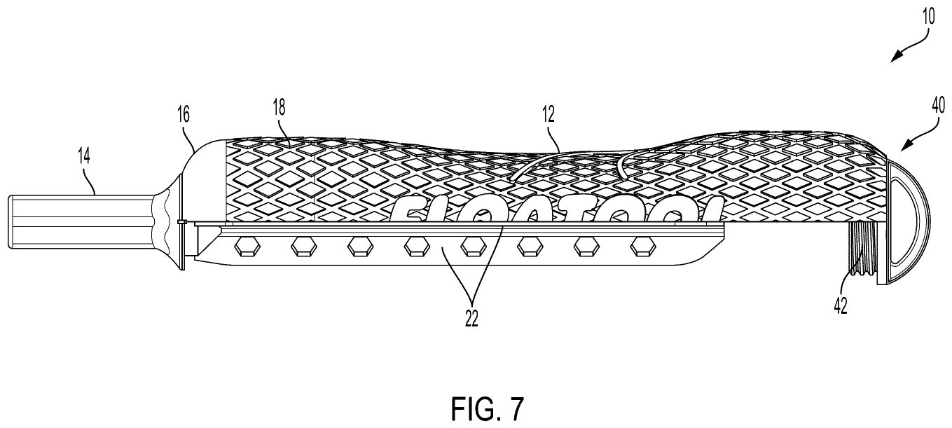

FIG. 7 shows a Front view of the hand tool.

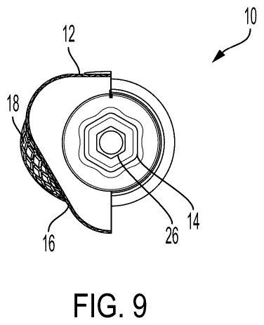

FIG. 9 shows another Front Section view of the hand tool.

In some embodiments, the shank 14 and or the grip material 18 may include strontium oxide aluminate, or similar coating, which can make the tool glow in the dark.

The resulting design and construction provide a hand tool that is durable, light weight, stiff, non-conductive, buoyant, and most of all-comfortable to use and suitable for a wide range of applications.

What is claimed is:

1. A torque transmission hand tool, comprising:
a central shank formed of dimensionally stable plastic material and including an axial opening at one end;
a first plurality of radially outward-protruding splines attached to an axial portion of the central shank away from the axial opening of the shank;
an outer shell surrounding the axial portion of the central shank having splines; and
closed cell foam filling the space between the outer shell and the radially-outward protruding splines so as to transfer torque from the outer shell through the splines to the central shank,
wherein the outer shell has an irregular internal shape that grips the closed cell foam to transfer torque from the outer shell through the foam to the first plurality of splines.

2. The tool of claim 1, further comprising a second plurality of radially-inward protruding splines attached to a portion of the outer shell at least partially overlapping with the radially-outward protruding splines.

3. The tool of claim 1, wherein the closed cell foam is a high-density foam.

4. The tool of claim 1, further comprising a head connected to the end of the shank that is distal from the outer shell.

5. The tool of claim 4, wherein the head is connected to the shank by inserting a hexagonal portion of the head into the axial opening at the end of the shank.

6. The tool of claim 1, wherein the outer shell has three portions of varied cross-sections:
a lower portion adjacent the shank, with a generally triangular cross section;
an intermediate portion adjacent the lower portion, with a generally cylindrical cross section that is smaller in cross-sectional area than the lower portion; and
an upper portion adjacent the intermediate portion, with a generally oblong cross section of cross-sectional area similar to the intermediate portion.

7. The tool of claim 1, further comprising a cap closing an end of the shell that is opposite the central shank.

8. The tool of claim 7, wherein the cap has at its inward surface a plurality of hexagonal cavities for receiving driver bits.

9. The tool of claim 1, further comprising a pliable covering on the outer shell.

10. The tool of claim 1, wherein the dimensionally stable plastic material is fiber-filled nylon-12.

11. The tool of claim 10, wherein the fibers are glass.

12. The tool of claim 10, wherein the fibers are carbon.
